(19) United States
(12) Patent Application Publication
(10) Pub. No.: US 2026/0160409 A1
(43) Pub. Date: Jun. 11, 2026

(54) LIGHT EMITTING MODULE

(71) Applicant: SEOUL VIOSYS CO., LTD., Ansan-si (KR)

(72) Inventor: JiHo KIM, Ansan-si (KR)

(73) Assignee: SEOUL VIOSYS CO., LTD., Ansan-si (KR)

(21) Appl. No.: 19/409,234

(22) Filed: Dec. 4, 2025

Related U.S. Application Data
(60) Provisional application No. 63/728,321, filed on Dec. 5, 2024.
(60) Provisional application No. 63/770,061, filed on Mar. 11, 2025.

(51) Int. Cl. F21V 23/00

(52) U.S. Cl. CPC F21V 23/005

(57) ABSTRACT

A light emitting module includes a substrate; a plurality of light emitting devices disposed on the substrate, arranged in one direction, and configured to generate light; and a driving device configured to control generation of the light from the plurality of light emitting devices. The substrate includes a plurality of metal layers stacked to be electrically connected to at least one of the plurality of light emitting devices and the driving device; and a substrate insulating layer disposed between the plurality of metal layers. At least some of the plurality of metal layers are formed to have different lengths in the one direction when viewed from a cross section where the substrate is cut in the one direction.

### CROSS-REFERENCE TO RELATED APPLICATIONS

The present application claims the benefit of priority to U.S. Provisional Application Nos. 63/728,321, filed Dec. 5, 2024, and 63/770,061, filed Mar. 11, 2025, the entire contents of which are incorporated herein by reference.

### TECHNICAL FIELD

The present disclosure relates to a light emitting module.

### BACKGROUND

Light emitting diodes (LEDs) are widely used in light emitting modules. A light emitting diode converts an electrical signal into a form of light, such as infrared light, visible light, or ultraviolet light, by using characteristics of a compound semiconductor.

As a luminous efficiency of light emitting diodes is increased, light emitters are being applied to various fields, including display devices, lighting equipment, vehicle lamps, ships, and the like.

### SUMMARY

Exemplary embodiments of the present disclosure have been invented in view of the above background, and relate to providing a light emitting module comprising a plurality of light emitting devices that may be individually operated to generate light.

Furthermore, another object is to provide a light emitting module that is bendable.

In accordance with a first aspect of the present disclosure, there is provided a light emitting module including: a substrate; a plurality of light emitting devices disposed on the substrate, arranged in one direction, and configured to generate light; and a driving device configured to control generation of the light from the plurality of light emitting devices, wherein the substrate includes: a plurality of metal layers stacked to be electrically connected to at least one of the plurality of light emitting devices and the driving device; and a substrate insulating layer disposed between the plurality of metal layers, wherein at least some of the plurality of metal layers are formed to have different lengths in the one direction when viewed from a cross section where the substrate is cut in the one direction.

Further, one of the plurality of metal layers may include: a plurality of metal regions arranged spaced apart from each other in the one direction within the cross section. A length in the one direction of one of the plurality of metal regions may be longer than a length in the one direction of another of the plurality of metal regions.

Further, the one metal region and the another metal region among the plurality of metal regions may be alternately arranged with each other in the one direction.

Further, a length in the one direction of one of the plurality of metal layers within the cross section may be longer than a length in the one direction of another of the plurality of metal layers.

Further, the one of the plurality of metal layers and the another of the plurality of metal layers may be alternately stacked with each other within the cross section.

Further, the plurality of metal layers may include: a first metal layer disposed on an upper surface of the substrate insulating layer and including a first metal region extending in the one direction; a second metal layer disposed below the first metal layer, extending in the one direction, and including a second metal region arranged such that at least a portion of the second metal region overlaps with the first metal region when projected upward; a third metal layer disposed below the second metal layer, extending in the one direction, and including a third metal region arranged such that at least a portion of the third metal region overlaps with the first metal region and the second metal region when projected upward; a fourth metal layer disposed below the third metal layer, extending in the one direction, and including a fourth metal region arranged such that at least a portion of the fourth metal region overlaps with the third metal region when projected upward; and a fifth metal layer disposed below the fourth metal layer, extending in the one direction, and including a fifth metal region arranged such that at least a portion of the fifth metal region overlaps with the fourth metal region when projected upward.

Further, a length in the one direction of the first metal region may be longer than a length in the one direction of the second metal region, a length in the one direction of the fourth metal region may be longer than the length in the one direction of the first metal region, a length in the one direction of the fifth metal region may be longer than the length in the one direction of the fourth metal region, and a length in the one direction of the third metal region may be longer than the length in the one direction of the fifth metal region.

Further, the substrate may further includes a metal connector extending in a stacking direction and connected to the plurality of metal layers.

Further, the plurality of light emitting devices and the driving device may be arranged to be spaced apart from each other in the one direction, and a separation distance between the plurality of light emitting devices may be smaller than a separation distance between one of the plurality of light emitting devices and the driving device.

In accordance with a second aspect of the present disclosure, there is provided a light emitting module including: a substrate; a plurality of light emitting devices disposed on the substrate, arranged in one direction, and configured to generate light; and a driving device configured to control generation of the light from the plurality of light emitting devices, wherein the substrate includes a plurality of metal layers stacked to be electrically connected to the driving device and the plurality of light emitting devices, and wherein when the plurality of metal layers are projected onto a single virtual plane, at least some of the plurality of metal layers are arranged to intersect with each other.

Further, the plurality of metal layers may include: a first metal layer, at least a portion of which extends in the one direction and is electrically connected to the plurality of light emitting devices; a second metal layer disposed below the first metal layer, electrically connected to the plurality of light emitting devices, and intersecting with the first metal layer as at least a portion of the second metal layer extends in a direction offset from the one direction when viewed from above; and a third metal layer disposed below the second metal layer, and extending in the direction offset from the one direction so that at least a portion of the third metal layer intersects with the first metal layer and the second metal layer.

In accordance with a third aspect of the present disclosure, there is provided a light emitting module including: a substrate; a plurality of light emitting devices disposed on the substrate and configured to generate light; and a plurality of driving devices configured to control the plurality of light emitting devices so that the light is generated from the plurality of light emitting devices, wherein the plurality of light emitting devices are arranged in one direction, the plurality of driving devices are spaced apart from the plurality of light emitting devices in another direction perpendicular to the one direction and are spaced apart from each other and arranged along the one direction, and a number of the plurality of light emitting devices is greater than a number of the plurality of driving devices.

Further, the substrate may include: a light emitting device placement region where the plurality of light emitting devices are disposed; and a driving device placement region where the plurality of driving devices are disposed, wherein the light emitting device placement region and the driving device placement region extend in the one direction, and a length in the one direction of the light emitting device placement region is greater than a length in the one direction of the driving device placement region.

Further, the light emitting device placement region and the driving device placement region may be disposed to be spaced apart from each other in the another direction, and a separation distance between the light emitting device placement region and the driving device placement region may be smaller than a separation distance in the another direction between one of the plurality of light emitting devices and one of the plurality of driving devices.

Further, the light emitting device placement region may extend from one side surface of one light emitting device of the plurality of light emitting devices disposed closest to one side of the substrate to another side surface, opposite the one side surface, of another light emitting device of the plurality of light emitting devices disposed closest to another side opposite the one side of the substrate, and the one side surface of the one light emitting device of the plurality of light emitting devices may be disposed toward the one side of the substrate, and the another side surface of the another light emitting device of the plurality of light emitting devices may be disposed toward the another side of the substrate.

Further, the driving device placement region may extend from one side surface of one driving device of the plurality of driving devices disposed closest to one side of the substrate to another side surface, opposite the one side surface, of another driving device of the plurality of driving devices disposed closest to another side of the substrate, the one side surface of the one driving device of the plurality of driving devices may be disposed toward the one side of the substrate, and the another side surface of the another driving device of the plurality of driving devices may be disposed toward the another side of the substrate.

Further, a separation distance between the plurality of light emitting devices may be smaller than a separation distance between the plurality of driving devices.

Further, an area of the light emitting device placement region may be smaller than an area of the driving device placement region.

Further, each of the plurality of light emitting devices may include: a light emitter configured to generate light; a pad disposed below the light emitter and electrically connected to the light emitter; and a lead connector disposed between the light emitter and the pad to electrically connect the light emitter and the pad, wherein an area of the lead connector is larger than an area of the pad.

Further, the light emitting module may further include: a device insulating layer that covers the light emitter, the pad, and the lead connector. The device insulating layer may include: a first device insulating layer disposed on an upper side of the light emitter; a second device insulating layer disposed on a side surface of the light emitter; a third device insulating layer disposed on the side surface of the light emitter and disposed below the second device insulating layer; and a fourth device insulating layer disposed below the light emitter and the third device insulating layer, and covering at least a portion of the lead connector and the pad, wherein a light transmittance of the second device insulating layer is lower than a light transmittance of the first device insulating layer.

An embodiment of the present disclosure may have an effect that a plurality of light emitting devices may be individually driven.

Furthermore, the embodiment of the present disclosure may have an effect of being able to efficiently dissipate heat from a light emitting device and a driving device to an outside.

Furthermore, the embodiment of the present disclosure may have an effect of being able to reduce the stress accumulated on a substrate, even when the substrate is bent.

Furthermore, the embodiment of the present disclosure may have an effect of being able to reduce the bending of a substrate due to heat generated from a driving device.

Furthermore, in the embodiment, at least some of a plurality of metal layers may be arranged to intersect with each other when viewed from above, so a connection distance may be reduced, and thus a signal interference may be reduced.

Furthermore, the embodiment of the present disclosure may have an effect of being able to diffuse light generated from a light emitter, so that the light extraction efficiency may be enhanced.

### BRIEF DESCRIPTION OF THE DRAWINGS

FIG. 1 is a diagram illustrating a state in which a light emitting module according to a first embodiment is included in a vehicle lamp.

FIG. 2 is a diagram illustrating a state in which the light emitting module according to the first embodiment of the present disclosure is included in an artificial intelligence speaker.

FIG. 3 is a diagram illustrating the light emitting module according to the first embodiment of the present disclosure.

FIG. 4 is a cross sectional view of the light emitting module of FIG. 3 taken along line IV-IV.

FIG. 5 is a cross-sectional view of a first example of a light emitting module according to a second embodiment of the present disclosure.

FIG. 6 is a cross sectional view of a second example of the light emitting module according to the second embodiment of the present disclosure.

FIG. 7 is an enlarged view of a region C of a substrate of a light emitting module according to a third embodiment of the present disclosure.

FIG. 8 is an enlarged view of a first metal layer disposed in the region C of the substrate of FIG. 7 of the present disclosure.

FIG. 9 is an enlarged view of a second metal layer disposed in the region C of the substrate of FIG. 7 of the present disclosure.

FIG. 10 is an enlarged view of a third metal layer disposed in the region C of the substrate of FIG. 7 of the present disclosure.

FIG. 11 is an enlarged view of a fourth metal layer disposed in the region C of the substrate of FIG. 7 of the present disclosure.

FIG. 12 is a diagram illustrating a light emitting module according to a fourth embodiment of the present disclosure.

FIG. 13 is a diagram illustrating a light emitting device of the light emitting module of FIG. 12.

FIG. 14 is a cross-sectional view of the light emitting device of FIG. 13 taken along line XIV-XIV.

### DETAILED DESCRIPTION OF THE INVENTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a light emitting module 1 according to a first embodiment of the present disclosure will be described.

The light emitting module 1 according to the first embodiment of the present disclosure may generate light. In one embodiment, the light emitting module 1 may be included in a vehicle 2, an artificial intelligence speaker 3, a display device, or the like.

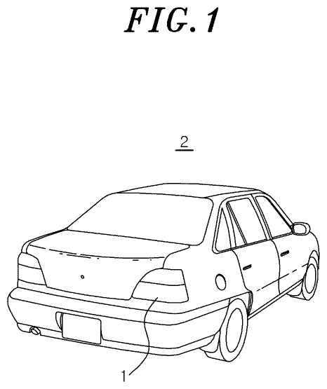

As illustrated in FIG. 1, the light emitting module 1 may be included in a vehicle lamp. The light emitting module 1 may reduce crosstalk for each projection area in a light emitting system that requires driving by area, such as a smart headlamp, thereby enabling the implementation of a clear projection image. In addition, the light emitting module 1 may be disposed along a curved surface of a vehicle to enhance aesthetics.

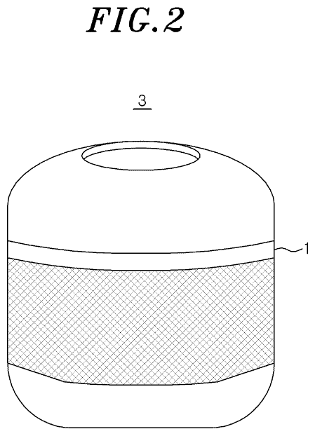

Furthermore, as illustrated in FIG. 2, the light emitting module 1 may be included in an artificial intelligence speaker 3. The light emitting module 1 may change color and generate light in response to a signal transmitted from the artificial intelligence speaker 3. In addition, the light emitting module 1 may generate light by adjusting a brightness or color thereof according to a surrounding environment.

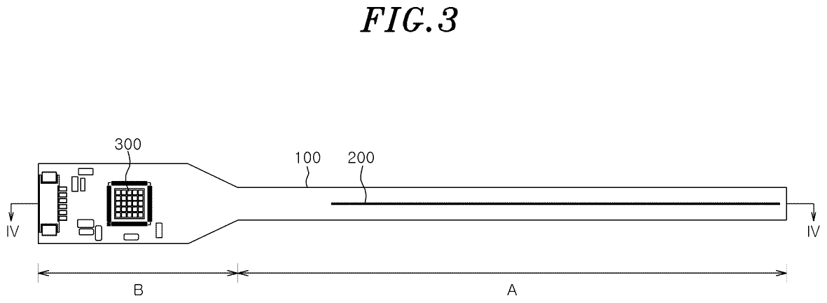

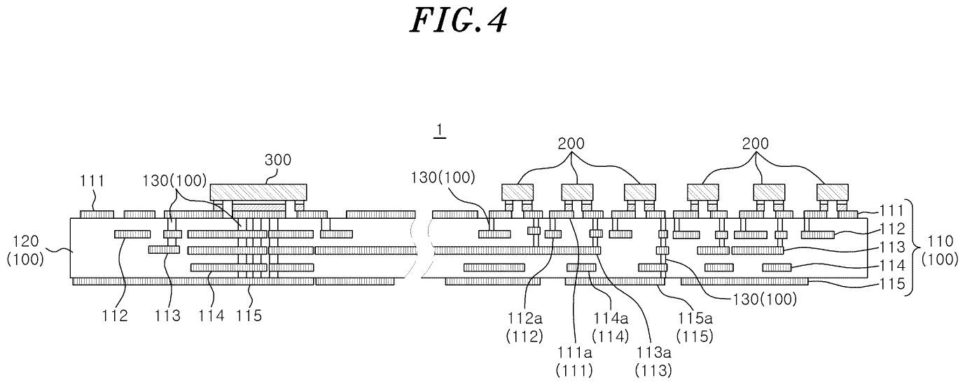

Referring to FIGS. 3 and 4, the light emitting module 1 may include a substrate 100, a light emitting device 200, and a driving device 300.

A plurality of light emitting devices 200 and driving devices 300 may be disposed on the substrate 100. In one embodiment, the substrate 100 may be a printed circuit board (PCB) on which an electric circuit is printed. In addition, the substrate 100 may be a thin-film transistor (TFT) backplane. The substrate 100 may include one or more of thermally conductive materials such as Cu, Zn, Au, Ni, Al, Mg, Cd, Be, W, Mo, Si, Ag, and Fe, or an alloy composed of some thereof, thereby increasing thermal and electrical conductivity. However, this is merely an example, and the substrate 100 may include one or more insulating materials such as FR1, CEM-1, FR-4, PMMA, PCT, and PPA to prevent a short circuit between circuits. Here, FR1 is a material in which a copper foil and a laminate paper are stacked, and CEM-1 is a material in which a copper foil, a glass fiber fabric, a laminate paper, and a glass fiber fabric are sequentially stacked. In addition, FR-4 is a material in which a copper foil and a glass fiber fabric or a glass fiber cloth are laminated. In addition, the substrate 100 may include a ceramic such as alumina (Al2O3), aluminum nitride (AlN), or zirconia toughened alumina (ZTA).

Furthermore, the substrate 100 may have flexibility. For example, one region of the substrate 100 may be bent along a curved outer surface shape such as on an artificial intelligence speaker or a vehicle. The substrate 100 may be formed to extend in one direction. A length of the substrate 100 in one direction may be longer than a length thereof in another direction perpendicular to the one direction. The substrate 100 may have a thickness smaller than a thickness of the light emitting device 200 and a thickness of the driving device 300 to have flexibility, but is not limited thereto.

Furthermore, the substrate 100 may include a light emitting device placement region A and a driving device placement region B.

The light emitting device placement region A is a region where the plurality of light emitting devices 200 are disposed. The light emitting device placement region A may be formed to extend in one direction. A length of the light emitting device placement region A in the one direction may be formed to be longer than a length of the driving device placement region B in the one direction.

The driving device placement region B is a region where the driving device 300 is disposed. The driving device placement region B and the light emitting device placement region A may be arranged in one direction. A width of the driving device placement region B perpendicular to one direction may be formed to be larger than a width of the light emitting device placement region A. In other words, a width of the driving device placement region B, where the driving device 300 that generates more heat than the light emitting device 200 is disposed, may be formed to be large, so heat dissipation efficiency may be increased. Accordingly, the reliability of the light emitting module 1 may be improved. A width of at least a portion of the driving device placement region B may be reduced as it extends toward the light emitting device placement region A. Accordingly, a stress applied to a portion connecting the driving device placement region B to the light emitting device placement region A may be reduced to increase structural stability.

Furthermore, the substrate 100 may include a metal layer 110, a substrate insulating layer 120, and a metal connector 130.

The metal layer 110 may be electrically connected to the plurality of light emitting devices 200 and the driving device 300. The metal layer 110 may be a circuit of the substrate 100. For example, the metal layer may include Cu, W, Fe, or the like. In addition, a coating layer of Ag, Au, Ni, or the like may be formed on an upper surface of the metal layer. A plurality of the metal layers 110 may be formed. The plurality of metal layers 110 may be stacked on each other in an up-and-down direction. The plurality of metal layers 110 may be formed to extend in one direction in a cross section of the substrate 100. The cross section of the substrate 100 may be a cross section formed when the substrate 100 is cut in one direction.

In the cross section, an area occupied by one of the plurality of metal layers 110 may be formed to be larger than an area occupied by another of the plurality of metal layers 110, but is not limited thereto. In one embodiment, in the cross section, an area occupied by one of the plurality of metal layers 110 may be larger than an area occupied by another of the plurality of metal layers 110, but this is not limited thereto. In other words, in the cross section, an area occupied by one of the plurality of metal layers 110 may be the same as an area occupied by another of the plurality of metal layers 110. The plurality of metal layers 110 may be arranged in the form of wefts (extending horizontally) and warps (extending vertically) in different layers to form a multilayer woven structure. Accordingly, the substrate 100 may have a stable structure that is not damaged even when bent.

Furthermore, in a cross section, one of the plurality of metal layers 110 having a large area and another of the plurality of metal layers 110 having a small area may be alternately stacked with each other. In one embodiment, the metal layer 110 having a small area may be disposed between the metal layers 110 having a relatively large area in the up-and-down direction.

The plurality of metal layers 110 may include a first metal layer 111, a second metal layer 112, a third metal layer 113, a fourth metal layer 114, and a fifth metal layer 115, but is not limited thereto.

The first metal layer 111 may be disposed on an upper surface of the substrate insulating layer 120 and may be electrically connected to the plurality of light emitting devices 200 and the driving device 300. In addition, the first metal layer 111 may be disposed below the plurality of light emitting devices 200 and the driving device 300. The first metal layer 111 may include a plurality of metal regions 111a extending in one direction in a cross section.

The plurality of first metal regions 111a may be disposed to be spaced apart from each other in one direction. A length in one direction of one of the plurality of first metal regions 111a and a length in the one direction of another of the plurality of first metal regions 111a may be formed to be different from each other. One of the plurality of first metal regions 111a and another of the plurality of first metal regions 111a may be alternately arranged with each other in one direction, but is not limited thereto. In other words, a length in the one direction of one of the plurality of first metal regions 111a and a length in the one direction of another of the plurality of first metal regions 111a may be formed to be the same. An area of the plurality of first metal regions 111a may be formed to be larger than each of an area of a plurality of second metal regions 112a and an area of a plurality of third metal regions 113a, so that heat of the light emitting device 200 and the driving device 300 may be efficiently dissipated to the outside. In addition, a length of one of the plurality of first metal regions 111a may be formed to be longer than each of a length of one of a plurality of second metal regions 112a to be described below and a length of one of a plurality of third metal regions 113a, so that the light emitting device 200 may be stably attached even when the substrate 100 is bent.

The second metal layer 112 may be disposed below the first metal layer 111 and may be electrically connected to the plurality of light emitting devices 200 and the driving device 300. In addition, an outer surface of the second metal layer 112 may be covered by the substrate insulating layer 120. The second metal layer 112 may include a plurality of second metal regions 112a extending in one direction in a cross section.

The plurality of second metal regions 112a may be disposed to be spaced apart from each other in one direction. A length in one direction of one of the plurality of second metal regions 112a and a length in the one direction of another of the plurality of second metal regions 112a may be formed to be different from each other. In addition, one of the plurality of second metal regions 112a and another of the plurality of second metal regions 112a may be alternately arranged with each other in one direction, but is not limited thereto. In other words, a length in the one direction of one of the plurality of second metal regions 112a and a length in the one direction of another of the plurality of second metal regions 112a may be formed to be the same. One of the plurality of second metal regions 112a may be arranged such that at least a portion thereof overlaps with one of the plurality of first metal regions 111a when projected upward. A length in one direction of the projected second metal region 112a may be smaller than a length in the one direction of the first metal region 111a arranged to overlap therewith, but is not limited thereto. Accordingly, a tensile force generated by bending of the metal layer 110 may be effectively distributed, so that the light emitting device 200 may be stably attached even when the substrate 100 is bent.

The third metal layer 113 may be disposed below the second metal layer 112 and may be electrically connected to the plurality of light emitting devices 200 and the driving device 300. In addition, an outer surface of the third metal layer 113 may be covered by the substrate insulating layer 120. The third metal layer 113 may include a plurality of third metal regions 113a extending in one direction in a cross section.

The plurality of third metal regions 113a may be disposed to be spaced apart from each other in one direction. A length in one direction of one of the plurality of third metal regions 113a and a length in the one direction of another of the plurality of third metal regions 113a may be formed to be different from each other. In addition, one of the plurality of third metal regions 113a and another of the plurality of third metal regions 113a may be alternately arranged with each other in one direction, but is not limited thereto. In other words, a length in the one direction of one of the plurality of third metal regions 113a and a length in the one direction of another of the plurality of third metal regions 113a may be formed to be the same. Accordingly, a tensile force generated in the metal region 113a may be effectively distributed. One of the plurality of third metal regions 113a may be arranged such that at least a portion thereof overlaps with at least one of the plurality of second metal regions 112a and at least one of the plurality of first metal regions 111a when projected upward. Accordingly, a tensile force generated by bending of the metal layer 110 may be effectively distributed, so that the light emitting device 200 may be stably attached even when the substrate 100 is bent.

A length in one direction of the projected third metal region 113a may be formed to be larger than a length in the one direction of the first metal region 111a and a length in the one direction of the second metal region 112a, which are arranged to overlap therewith. Accordingly, a strength of the substrate 100 may be reinforced, so that the light emitting device 200 may be stably attached.

The fourth metal layer 114 may be disposed below the third metal layer 113 and may be electrically connected to the plurality of light emitting devices 200 and the driving device 300. In addition, an outer surface of the fourth metal layer 114 may be covered by the substrate insulating layer 120. Accordingly, the light emitting device 200 may be protected from an external stimulus such as a surge. The fourth metal layer 114 may include a plurality of fourth metal regions 114a extending in one direction in a cross section.

The plurality of fourth metal regions 114a may be disposed to be spaced apart from each other in one direction. A length in one direction of one of the plurality of fourth metal regions 114a and a length in the one direction of another of the plurality of fourth metal regions 114a may be formed to be different from each other. In addition, one of the plurality of fourth metal regions 114a and another of the plurality of fourth metal regions 114a may be alternately arranged with each other in one direction, but is not limited thereto. In other words, a length in the one direction of one of the plurality of fourth metal regions 114a and a length in the one direction of another of the plurality of fourth metal regions 114a may be formed to be the same. One of the plurality of fourth metal regions 114a may be arranged such that at least a portion thereof overlaps with at least one of the plurality of second metal regions 112a and at least one of the plurality of first metal regions 111a when projected upward. In addition, one of the plurality of fourth metal regions 114a may overlap with one of the plurality of third metal regions 113a when projected upward. A length in one direction of the projected third metal region 113a may be formed to be larger than a length in the one direction of the first metal region 111a and a length in the one direction of the second metal region 112a arranged to overlap therewith. A length in one direction of the projected third metal region 113a may be shorter than a length in the one direction of the third metal region 113a arranged to overlap therewith. When the lengths of the metal regions in each layer are formed differently, the bending stress applied to the metal may be effectively distributed, so the light emitting device 200 may be stably attached even when the substrate 100 is bent.

A length in one direction of the projected fourth metal region 114a may be formed to be larger than a length in the one direction of the first metal region 111a and a length in the one direction of the second metal region 112a arranged to overlap therewith. Accordingly, a strength of the substrate 100 may be increased, and the light emitting device 200 may be stably attached. In addition, a length in one direction of the projected fourth metal region 114a may be shorter than a length in the one direction of the third metal region 113a arranged to overlap therewith. When the lengths of the metal regions in each layer are formed differently, the bending stress applied to the metal may be effectively distributed, so the light emitting device 200 may be stably attached even when the substrate 100 is bent.

The fifth metal layer 115 may be disposed below the fourth metal layer 114 and may be electrically connected to the plurality of light emitting devices 200 and the driving device 300. In addition, the fifth metal layer 115 may be disposed on a lower surface of the substrate insulating layer 120. The fifth metal layer 115 may include a plurality of fifth metal regions 115a extending in one direction in a cross section.

The plurality of fifth metal regions 115a may be disposed to be spaced apart from each other in one direction. A length in one direction of one of the plurality of fifth metal regions 115a and a length in the one direction of another of the plurality of fifth metal regions 115a may be formed to be different from each other. In addition, one of the plurality of fifth metal regions 115a and another of the plurality of fifth metal regions 115a may be alternately arranged with each other in one direction, but is not limited thereto. In other words, a length in the one direction of one of the plurality of fifth metal regions 115a and a length in the one direction of another of the plurality of fifth metal regions 115a may be formed to be the same. One of the plurality of fifth metal regions 115a may be arranged such that at least a portion thereof overlaps with at least one of the plurality of second metal regions 112a and at least one of the plurality of first metal regions 111a when projected upward. In addition, one of the plurality of fifth metal regions 115a may be arranged such that at least a portion thereof overlaps with one of the plurality of fourth metal regions 114a when projected upward. In addition, one of the plurality of fifth metal regions 115a may overlap with one of the plurality of third metal regions 113a when projected upward. When the lengths of the metal regions of each layer are formed differently, the bending stress applied to the metal may be effectively distributed, so that the light emitting device 200 may be stably attached even when the substrate 100 is bent.

A length in one direction of the projected fifth metal region 115a may be formed to be larger than a length in the one direction of the first metal region 111a and a length in the one direction of the second metal region 112a arranged to overlap therewith. A length in one direction of the projected fifth metal region 115a may be shorter than a length in the one direction of the third metal region 113a arranged to overlap therewith. In addition, a length in one direction of the projected fifth metal region 115a may be longer than a length in the one direction of the fourth metal region 114a arranged to overlap therewith. When the lengths of the metal regions of each layer are formed differently, the bending stress applied to the metal may be effectively distributed, so that the light emitting device 200 may be stably attached even when the substrate 100 is bent.

Furthermore, an area of the plurality of fifth metal regions 115a may be formed to be larger than each of an area of the plurality of second metal regions 112a and an area of the plurality of third metal regions 113a, so that heat of the light emitting device 200 and the driving device 300 may be efficiently dissipated to the outside.

Meanwhile, a coating layer for protecting the metal layer 110 disposed on an upper surface or a lower surface of the substrate 100 may be additionally disposed. In other words, a coating layer may be coated on the first metal layer 111 and the fifth metal layer 115. The coating layer may include an insulating material to prevent dielectric breakdown. In addition, the coating layer may include a material for preventing oxidation of the metal layer. For example, the coating layer may include PSR, acrylic, methacryl, acrolitrile, urethane, or the like.

The metal layer 110 and the metal connector 130 may be disposed in the substrate insulating layer 120. The substrate insulating layer 120 may have flexibility and be bent. The substrate insulating layer 120 may be formed in a film form. For example, the substrate insulating layer 120 may include a film of polyester (PET), polyimide (PI), liquid crystal polymer (LCP), polyethylene naphthalate (PEN), or the like. Due to the substrate insulating layer 120, at least a portion of the substrate 100 may be bent. In addition, when the substrate insulating layer 120 is bent, the plurality of light emitting devices 200 and the driving device 300 may also be arranged along a bending direction of the substrate insulating layer 120.

The metal connector 130 may extend in the up-and-down direction and be connected to the plurality of metal layers 110. The metal connector 130 may be a circuit of the substrate. The plurality of metal layers 110 and the plurality of light emitting devices 200 and the driving device may be electrically connected by the metal connector 130. In addition, the metal connector 130 may reduce stress received by the substrate 100 in the up-and-down direction.

A plurality of the metal connectors 130 may be formed. One of the plurality of metal connectors 130 may be connected to some of the plurality of metal layers 110. Another of the plurality of metal connectors 130 may be connected to the plurality of metal layers 110.

Meanwhile, an area of the metal layer 110 disposed in the driving device placement region B per unit area may be formed to be larger than an area of the metal layer 110 disposed in the light emitting device placement region A. In other words, a width of each of the plurality of metal layers 110 may be formed to be longer when disposed in the driving device placement region B than when disposed in the light emitting device placement region A, thereby reducing bending of the substrate 100 due to heat generated from the driving device 300.

Furthermore, the number of metal connectors 130 disposed in the driving device placement region B per unit area may be greater than the number of metal connectors 130 disposed in the light emitting device placement region A per unit area. In addition, the number of metal connectors 130 disposed directly therebelow the driving device 300 may be greater than the number of metal connectors 130 disposed directly therebelow the light emitting device 200 to increase heat dissipation and reduce deformation of the substrate 100 due to heat.

Furthermore, a length of a metal region disposed in the light emitting device placement region A may be formed to be shorter than a length of a metal region disposed in the driving device placement region B to increase flexibility of the substrate 100. The number of metal regions disposed in the light emitting device placement region A may be greater than the number of metal regions disposed in the driving device placement region B.

A metal connector 130 may be absent in a region directly therebelow the light emitting device 200 in the light emitting device placement region A. When the substrate 100 is bent, a larger curvature may be formed in an outer region of the light emitting device 200 than in the relatively rigid light emitting device 200, and a stress applied to the substrate 100 may be relieved through the metal connector 130 so that the stress accumulated on the substrate 100 may be reduced.

The light emitting device 200 may be disposed on the substrate 100 to generate light. In other words, the light emitting device 200 may be disposed on an upper surface of the first metal layer 111. In addition, a plurality of the light emitting devices 200 may be formed and arranged to be spaced apart from each other in one direction. The plurality of light emitting devices 200 may generate light of the same peak wavelength, but is not limited thereto, and at least some thereof may generate light of different peak wavelengths.

The driving device 300 may be disposed on the substrate 100 to control the plurality of light emitting devices 200 so that light is generated from the plurality of light emitting devices 200. In other words, the driving device 300 may supply a voltage to the plurality of light emitting devices 200. When the driving device 300 is viewed from above, an area of the driving device 300 may be formed to be larger than an area of one light emitting device 200.

The driving device 300 may individually drive the plurality of light emitting devices 200. There may be one driving device 300. The driving device 300 and the plurality of light emitting devices 200 may be arranged in one direction. A separation distance in one direction between one of the plurality of light emitting devices 200 and the driving device 300 may be formed to be longer than a separation distance in one direction between the plurality of light emitting devices 200.

Hereinafter, operations and effects of the light emitting module 1 according to the first embodiment of the present disclosure will be described.

The light emitting module 1 may individually drive the plurality of light emitting devices 200.

Furthermore, the light emitting module 1 may efficiently dissipate heat from the light emitting device 200 and the driving device 300 to the outside.

Furthermore, the light emitting module 1 may reduce the stress accumulated on the substrate 100.

Furthermore, the light emitting module 1 may reduce bending of the substrate 100 due to heat generated from the driving device 300.

Hereinafter, a light emitting module 1 according to a second embodiment of the present disclosure will be described.

In describing the second embodiment, there are differences in the arrangement of the plurality of metal layers 110, so these differences will be mainly described.

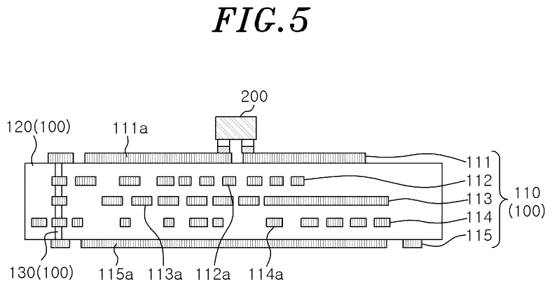

Referring to FIG. 5, as a first example, the number of the first metal regions 111a may be smaller than the number of the second metal regions 112a. A length in one direction of the first metal region 111a may be formed to be longer than a length in one direction of the second metal region 112a. In addition, the number of the third metal regions 113a may be smaller than the number of the second metal regions 112a and may be greater than a number of the first metal regions 111a. A length in one direction of the third metal region 113a may be formed to be longer than a length in one direction of the second metal region 112a. In addition, a number of the fourth metal regions 114a may be greater than a number of the third metal regions 113a. A length in one direction of the fourth metal region 114a may be shorter than a length in one direction of the third metal region 113a and the first metal region 111a. The number of the fifth metal regions 115a may be smaller than a number of the second metal regions 112a, the third metal regions 113a, and the fourth metal regions 114a. A length in one direction of the fifth metal region 115a may be formed to be longer than a length in one direction of the fourth metal region 114a. When the substrate 100 is bent, the plurality of metal layers 110 may mitigate the stress applied to the substrate 100.

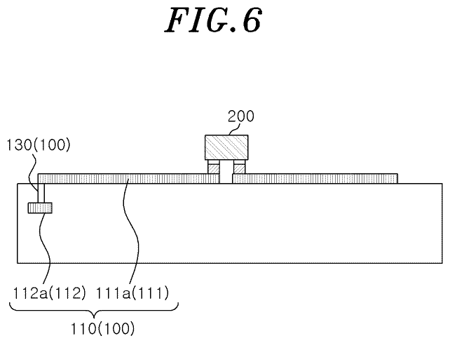

Referring to FIG. 6, as a second example, when the number of light emitting devices 200 disposed on the substrate 100 is small, the number of metal layers 110 may be decreased, so design difficulty may be reduced. In other words, the substrate 100 may include a first metal layer 111 and a second metal layer 112. In addition, the number of first metal regions 111a of the first metal layer 111 may be greater than the number of second metal regions 112a of the second metal layer 112. A length of the first metal region 111a may be formed to be longer than a length of the second metal region 112a. In the second example, the light emitting device 200 and the metal layer 110 may be disposed in one end region of the light emitting device placement region A, and may be disposed in a region of the light emitting device placement region A that is farthest from the driving device placement region B.

Hereinafter, operations and effects of the light emitting module 1 according to the second embodiment of the present disclosure will be described.

When the substrate 100 of the light emitting module 1 of the present disclosure is bent, the stress applied to the substrate 100 may be mitigated by the plurality of metal layers 110.

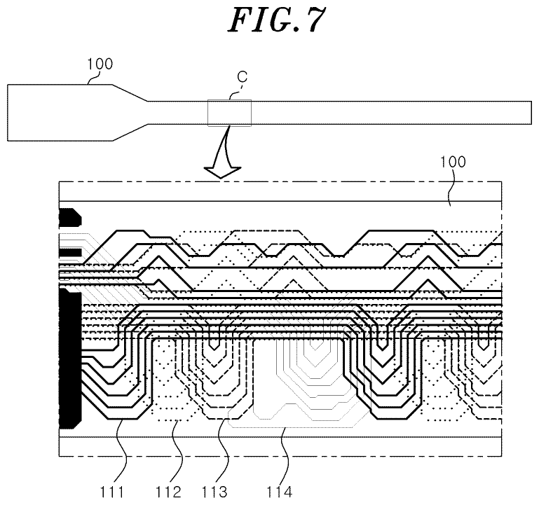

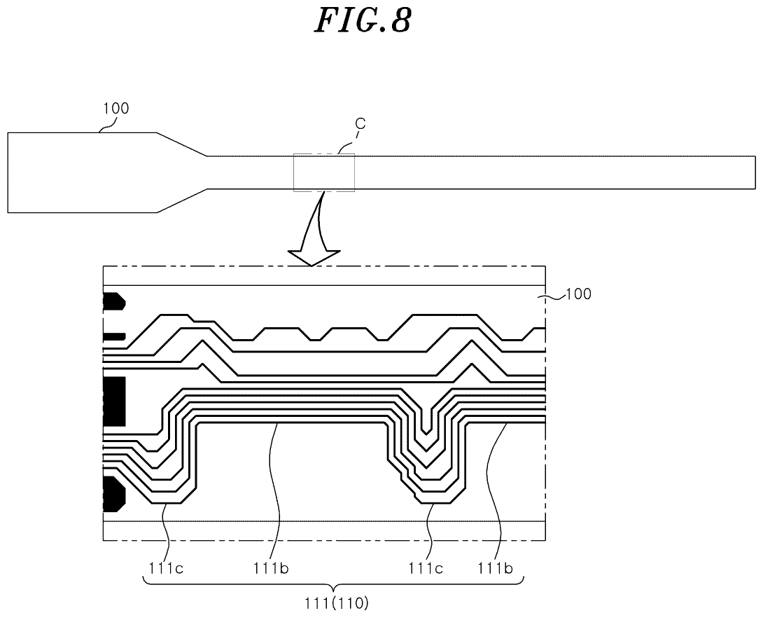

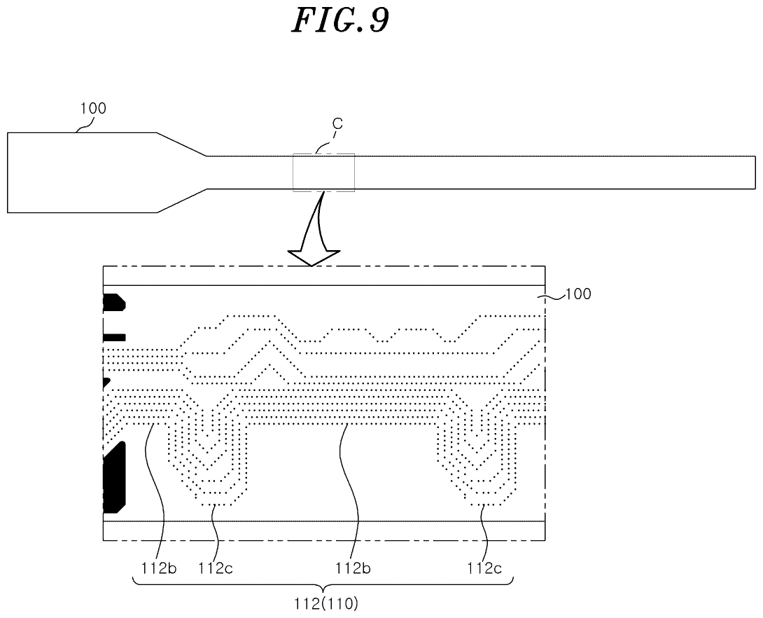

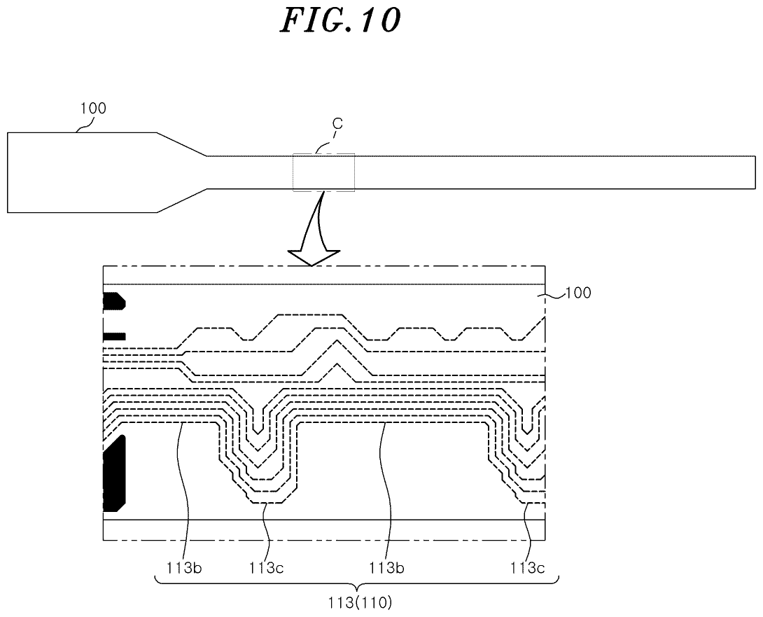

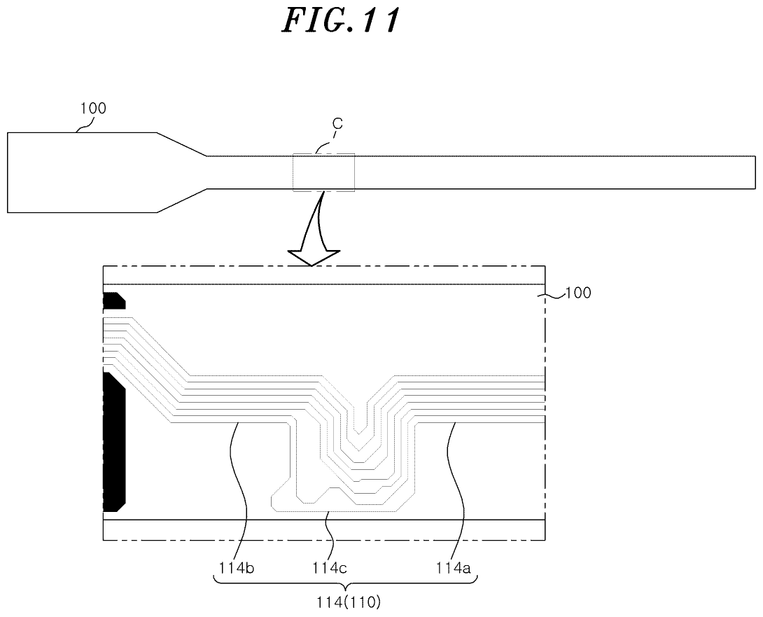

Hereinafter, a light emitting module 1 according to a third embodiment of the present disclosure will be described with reference to FIGS. 7 to 11.

In describing the third embodiment, there is a difference in that at least some of the plurality of metal layers 110 of the light emitting module 1 may be arranged to intersect with each other when viewed from above, so this difference will be mainly described.

When the plurality of metal layers 110 are projected onto a single virtual plane, at least some of the plurality of metal layers may be arranged to intersect with each other on the substrate.

The plurality of metal layers 110 may extend in one direction and extend in another direction that is an offset direction from the one direction. In other words, each of the plurality of metal layers 110 may include an extended region extending in one direction and an offset region extending in another direction. The extended region and the offset region may be disposed directly below the plurality of light emitting devices. In addition, the lower a position where the offset region is disposed in the plurality of metal layers 110, the further the offset region may be disposed to be spaced apart from the driving device 300, but is not limited thereto. An extended region of one of the plurality of metal layers 110 and an offset region of another of the plurality of metal layers 110 may overlap with each other. Accordingly, a tensile force generated by bending of the metal layer 110 may be effectively distributed, so that the light emitting device 200 may be stably attached even when the substrate 100 is bent.

The first metal layer 111 may include a first extended region 111b extending in one direction and a first offset region 111c extending in a direction offset from the one direction. In addition, the first offset region 111c and the first extended region 111b may be alternately arranged with each other in one direction. Accordingly, a fracture strength of the substrate 100 may be improved, and the light emitting device 200 may be stably attached.

The second metal layer 112 may be formed such that at least a portion thereof intersects with at least one of the first metal layer 111, the third metal layer 113, and the fourth metal layer 114. The second metal layer 112 may include a second extended region 112b extending in one direction and a second offset region 112c extending in a direction offset from the one direction. A separation distance in one direction between the second offset region 112c and the driving device 300 may be formed to be longer than a separation distance in one direction between the first offset region 111c and the driving device 300 in a predetermined region C when viewed from above. The second offset region 112c may be disposed to overlap with the first extended region 111b, a third extended region 113b to be described below, and a fourth extended region 114b in the region C when viewed from above. In addition, the second offset region 112c may be disposed between the first offset region 111c and a third offset region 113c to overlap with the first offset region 111c and the third offset region 113c in the region C when viewed from above. The second metal layer 112 may intersect with the first metal layer 111 in a predetermined region. Since a fracture strength of the substrate 100 may be improved by the metal layers 110 arranged to intersect with each other, the light emitting device 200 may be stably attached.

Furthermore, the second offset region 112c and the second extended region 112b may be alternately arranged with each other in one direction.

The third metal layer 113 may be formed such that at least a portion thereof intersects with at least one of the first metal layer 111, the second metal layer 112, and the fourth metal layer 114. The third metal layer 113 may include a third extended region 113b extending in one direction and a third offset region 113c extending in a direction offset from the one direction. A separation distance in one direction between the third offset region 113c and the driving device 300 may be formed to be longer than a separation distance in one direction between the second offset region 112c and the driving device 300 in the region C when viewed from above. The third offset region 113c may be disposed to overlap with the first extended region 111b, the second extended region 112b, and the fourth extended region 114b in the region C when viewed from above. In addition, the third offset region 113c may be disposed between the second offset region 112c and a fourth offset region 114c to overlap with the second offset region 112c and the fourth offset region 114c in the region C when viewed from above. The third metal layer 113 may intersect with the second metal layer 112 in a predetermined region.

Furthermore, the third offset region 113c and the third extended region 113b may be alternately arranged with each other in one direction.

The fourth metal layer 114 may be formed to intersect with the first metal layer 111, the second metal layer 112, and the third metal layer 113. The fourth metal layer 114 may include a fourth extended region 114b extending in one direction and a fourth offset region 114c extending in a direction offset from the one direction. A separation distance in one direction between the fourth offset region 114c and the driving device 300 may be formed to be longer than a separation distance in one direction between the third offset region 113c and the driving device 300 in the region C when viewed from above. The fourth offset region 114c may be disposed to overlap with the first extended region 111b, the second extended region 112b, and the third extended region 113b in the region C when viewed from above. In addition, the fourth offset region 114c may be disposed between the third offset region 113c and the first offset region 111c to overlap with the third offset region 112c and the first offset region 111c in the region C when viewed from above. The fourth metal layer 114 may intersect with the third metal layer 113 in a predetermined region.

Furthermore, the fourth offset region 114c and the fourth extended region 114b may be alternately arranged with each other in one direction.

Hereinafter, operations and effects of the light emitting module 1 according to the third embodiment of the present disclosure will be described.

At least some of the plurality of metal layers 110 of the present disclosure may be arranged to intersect with each other when viewed from above, so a connection distance may be reduced, and thus signal interference may be reduced.

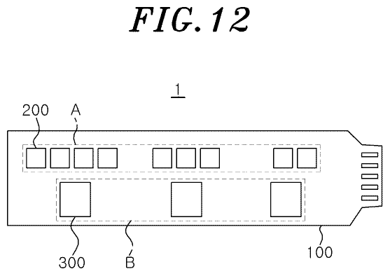

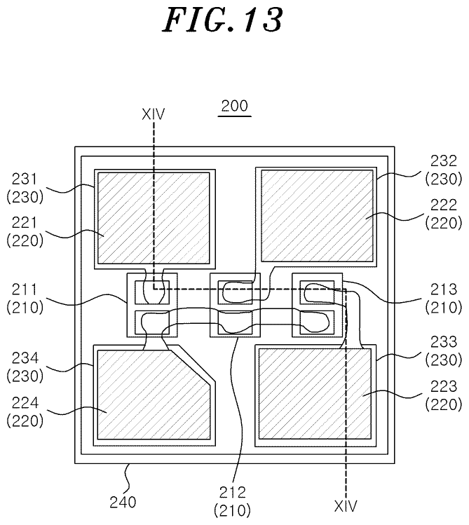

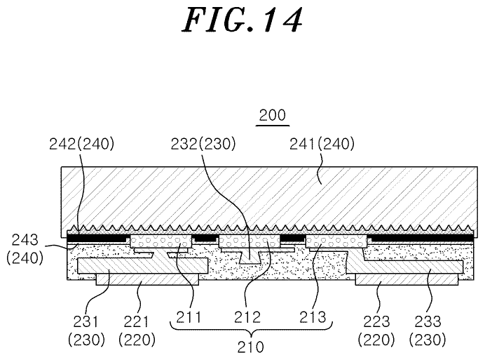

Hereinafter, a light emitting module 1 according to a fourth embodiment of the present disclosure will be described with reference to FIGS. 12 to 14.

In describing the fourth embodiment, there is a difference in the arrangement of the plurality of light emitting devices 200 and the driving device 300, so this difference will be mainly described.

A plurality of the driving devices 300 may be formed. The number of the plurality of driving devices 300 may be fewer than the number of the plurality of light emitting devices 200. The plurality of driving devices 300 may be arranged to be spaced apart from each other in one direction in which the plurality of light emitting devices 200 are arranged, and may be disposed to be spaced apart from the plurality of light emitting devices 200 in another direction. The another direction may be a direction perpendicular to the one direction. A separation distance between the plurality of light emitting devices 200 may be smaller than a separation distance between the plurality of driving devices 300.

The light emitting device placement region A may be a region where the plurality of light emitting devices 200 are disposed. In other words, the plurality of light emitting devices 200 may be disposed to be spaced apart from each other in one direction inside the light emitting device placement region A. The light emitting device placement region A may extend in one direction. The plurality of light emitting devices 200 may be disposed to be spaced apart along one direction of the light emitting device placement region A. In other words, a length (long axis) in one direction of the light emitting device placement region A may be longer than a length (short axis) in another direction perpendicular to the one direction (long axis) of the light emitting device placement region A. In addition, a length in one direction of the light emitting device placement region A may be larger than a length in one direction of the driving device placement region B.

In one embodiment, the light emitting device placement region A may extend from one side surface of one of the plurality of light emitting devices 200 disposed closest to one side of the substrate 100 to another side surface, opposite one side surface, of another of the plurality of light emitting devices 200 disposed closest to another side opposite the one side of the substrate 100. Here, one side surface of one of the plurality of light emitting devices 200 may be disposed toward one side of the substrate 100. In addition, another side surface of another of the plurality of light emitting devices 200 may be disposed toward another side of the substrate 100. In another embodiment, the light emitting device placement region A may be formed such that one side thereof is disposed between one side of the substrate 100 and one of the plurality of light emitting devices 200 disposed closest to the one side of the substrate 100, and another side thereof is disposed between another side of the substrate 100 and another of the plurality of light emitting devices 200 disposed closest to the another side of the substrate 100.

Furthermore, a length in another direction of the light emitting device placement region A may be smaller than a length in another direction of the driving device placement region B. An area of the light emitting device placement region A may be smaller than an area of the driving device placement region B. An area of the driving device placement region B where the driving device 300 that generates more heat than the light emitter 210 is disposed may be formed to be large, so that the heat dissipation efficiency may be increased.

The driving device placement region B is a region where a plurality of driving devices are disposed. In other words, the plurality of driving devices 300 may be disposed to be spaced apart from each other in one direction inside the driving device placement region B. The driving device placement region B may extend in one direction. A length in one direction of the driving device placement region B may be longer than a length in a direction perpendicular to the one direction of the driving device placement region B. For example, the driving device placement region B may extend from one side surface of one of the plurality of driving devices 300 disposed closest to one side of the substrate 100 to another side surface, opposite one side surface, of another of the plurality of driving devices 300 disposed closest to another side of the substrate 100. Here, one side surface of one of the plurality of driving devices 300 may be disposed toward one side of the substrate 100. In addition, another side surface of another of the plurality of driving devices 300 may be disposed toward another side of the substrate 100.

The light emitting device placement region A and the driving device placement region B may be disposed to be spaced apart from each other in another direction. The light emitting device placement region A and the driving device placement region B may not overlap with each other. The light emitting device placement region A and the driving device placement region B may reduce overlapping of heat sources to increase the heat dissipation efficiency. A separation distance between the light emitting device placement region A and the driving device placement region B may be smaller than a separation distance in another direction between one of the plurality of light emitting devices 200 and one of the plurality of driving devices 300, but is not limited thereto. In other words, at least a portion of the light emitting device placement region A and the driving device placement region B may overlap with each other. When at least a portion of the light emitting device placement region A and the driving device placement region B overlap with each other, a circuit connection distance may be reduced, so that the signal interference may be reduced.

The light emitting device 200 may include a light emitter 210, a pad 220, a lead connector 230, and a device insulating layer 240.

A plurality of the light emitters 210 may be formed to generate light. At least some of the plurality of light emitters 210 may generate light of different peak wavelengths. In addition, the plurality of light emitters 210 may generate white light having different color temperatures. In addition, each of the plurality of light emitters 210 may include an n-type semiconductor layer, an active layer, and a p-type semiconductor layer. In addition, at least some of the plurality of light emitters 210 may have different power consumptions and may have different driving voltages. The plurality of light emitters 210 may include a first light emitter 211, a second light emitter 212, and a third light emitter 213.

The first light emitter 211 may generate light. For example, the first light emitter 211 may generate red light. In addition, the first light emitter 211 may have a voltage of 1.8 V to 2.3 V at 1 mA.

The second light emitter 212 may generate light. For example, the second light emitter 212 may generate blue light. In addition, the second light emitter 212 may have a voltage of 2.4 V to 3.1 V at 1 mA.

The third light emitter 213 may generate light. For example, the third light emitter 213 may generate green light. Alternatively, the third light emitter 213 may have a voltage of 2.6 V to 3.2 V at 1 mA. In other words, the third light emitter 213 has a higher power consumption than the first light emitter 211 and the second light emitter 212, and may dissipate the highest heat.

The pad 220 may be disposed below the light emitter 210 and may be electrically connected to the light emitter 210 and the substrate 100. A plurality of the pads 220 may be formed. The plurality of pads 220 may include Cu, W, Ni, Fe, Au, Ag, or the like with high electrical conductivity. The plurality of pads 220 may include a first pad 221, a second pad 222, a third pad 223, and a fourth pad 224.

The first pad 221 may be electrically connected to the first light emitter 211. In other words, the first pad 221 may be electrically connected to a p-type semiconductor layer of the first light emitter 211. The first pad 221 may be disposed below a first lead connector 231 to be described below.

The second pad 222 may be electrically connected to the second light emitter 212. In other words, the second pad 222 may be electrically connected to a p-type semiconductor layer of the second light emitter 212. In addition, the second pad 222 may be disposed below a second lead connector 232 to be described below.

The third pad 223 may be electrically connected to the third light emitter 213. In other words, the third pad 223 may be electrically connected to a p-type semiconductor layer of the third light emitter 213. In addition, the third pad 223 may be disposed below a third lead connector 233 to be described below.

The fourth pad 224 may be electrically connected to the first light emitter 211, the second light emitter 212, and the third light emitter 213. In other words, the fourth pad 224 may be electrically connected to n-type semiconductor layers of the first light emitter 211, the second light emitter 212, and the third light emitter 213. The fourth pad 224 may be a common electrode. In addition, the fourth pad 224 may be disposed below a fourth lead connector 234 to be described below.

The lead connector 230 may be disposed between the pad 220 and the light emitter 210 so that the pad 220 and the light emitter 210 are electrically connected. The lead connector 230 may include Cu, W, Ni, Fe, Au, Ag, or the like with high electrical conductivity. An area of the lead connector 230 may be formed to be larger than an area of the pad 220. The lead connector 230 may dissipate heat generated from the light emitter 210. The lead connector 230 may include a first lead connector 231, a second lead connector 232, a third lead connector 233, and a fourth lead connector 234.

The first lead connector 231 may be disposed between the first light emitter 211 and the first pad 221. In addition, an area of the first lead connector 231 may be formed to be larger than an area of the first light emitter 211. The first lead connector 231 may electrically connect the first light emitter 211 and the first pad 221, and may dissipate heat from the first light emitter 211. In addition, the first lead connector 231 may be disposed closer to the first pad 221 than to the first light emitter 211.

The second lead connector 232 may be disposed between the second light emitter 212 and the second pad 222. In addition, an area of the second lead connector 232 may be formed to be larger than an area of the second light emitter 212. The second lead connector 232 may electrically connect the second light emitter 212 and the second pad 222, and may dissipate heat from the second light emitter 212. In addition, the second lead connector 232 may be disposed closer to the second pad 222 than to the second light emitter 212.

The third lead connector 233 may be disposed between the third light emitter 213 and the third pad 223. In addition, an area of the third lead connector 233 may be formed to be larger than an area of the third light emitter 213. The third lead connector 233 may electrically connect the third light emitter 213 and the third pad 223, and may dissipate heat from the third light emitter 213. In addition, the third lead connector 233 may be disposed closer to the third pad 223 than to the third light emitter 213. In addition, since the most heat may be generated from the third light emitter 213, an area of the third lead connector 233 may be made larger than that of each of the first lead connector 231, the second lead connector 232, and the fourth lead connector 234.

The fourth lead connector 234 may be disposed between a fourth light emitter 214 and the fourth pad 224. In addition, an area of the fourth lead connector 234 may be formed to be larger than an area of the fourth light emitter 214. The fourth lead connector 234 may electrically connect the fourth light emitter 214 and the fourth pad 224, and may dissipate heat from the fourth light emitter 214. In addition, the fourth lead connector 234 may be disposed closer to the fourth pad 224 than to the fourth light emitter 214.

The device insulating layer 240 may cover the plurality of light emitters 210, the plurality of pads 220, and the plurality of lead connectors 230. The device insulating layer 240 may include a first device insulating layer 241, a second device insulating layer 242, a third device insulating layer 243, and a fourth device insulating layer 244.

The first device insulating layer 241 is disposed above the plurality of light emitters 210 and may have light transmittance. In other words, light generated from the plurality of light emitters 210 may be transmitted through the first device insulating layer 241. The first device insulating layer 241 may include sapphire, silicon, epoxy, or the like. In one embodiment, the first device insulating layer 241 may be a growth substrate for growing a gallium nitride-based semiconductor layer, for example, a sapphire substrate, a silicon substrate, a SiC substrate, a spinel substrate, or a Ga2O3 substrate. Irregularities may be formed on a lower surface of the first device insulating layer 241. For example, the irregularities may be a pattern protruding in an irregular shape from the lower surface of the first device insulating layer 241 toward the light emitter 210. In another embodiment, the irregularities may be formed as a triangular pyramid, a quadrangular pyramid, a polygonal pyramid, a hemisphere, a truncated pyramid having a curved surface, or the like. Due to these irregularities, the light generated from the light emitter 210 may be diffused, thereby improving the light extraction efficiency.

The second device insulating layer 242 may be disposed on a side surface of the plurality of light emitters 210 and below the first device insulating layer 241. The second device insulating layer 242 may reduce dielectric breakdown of the light emitter 210 due to surge stress, thereby improving reliability. In addition, the second device insulating layer 242 may include low light-transmitting particles. The low light-transmitting particles may include light-absorbing particles containing Cr, C, or the like, light-reflecting particles such as TiO2, BaSO4, or light-scattering particles such as SiO2. A path of light generated from the light emitter 210 may be adjusted by the low light-transmitting particles. A light transmittance of the second device insulating layer 242 may be lower than a light transmittance of the first device insulating layer 241.

The third device insulating layer 243 may be disposed on one side surface of the light emitter 210 and below the second device insulating layer 242. The third device insulating layer 243 may include a material that increases an adhesive force of the second device insulating layer 242. For example, the third device insulating layer 243 may include a thermosetting polymer material such as epoxy, urethane, or silicon. The light emitter 210 may be protected by the third device insulating layer 243.

The fourth device insulating layer 244 is disposed below the light emitter 210 and the third device insulating layer 243, and may cover at least a portion of the lead connector 230 and the pad 220. The fourth device insulating layer 244 may protect the lead connector 230 from an external environment. An opening may be formed in the fourth device insulating layer 244 so that the lead connector 230 and the light emitter 210 are electrically connected, and the lead connector 230 and the pad 220 are electrically connected. In addition, the fourth device insulating layer 244 may be disposed on one side surface of the pad 220 to protect the pad 220. In other words, the pad 220 may be disposed on a lower surface of the fourth device insulating layer 244.

Hereinafter, operations and effects of the light emitting module 1 according to the fourth embodiment of the present disclosure will be described.

The light emitting module 1 according to the fourth embodiment of the present disclosure may efficiently dissipate heat from the plurality of light emitters 210 to the outside.

Furthermore, the light emitting module 1 may diffuse light generated from the light emitter 210, so that light extraction efficiency may be enhanced.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

DESCRIPTION OF REFERENCE NUMERALS

| | |
|---|---|
| 1: light emitting module | 100: substrate |
| 110: metal layer | 111: first metal layer |
| 111a: first metal region | 111b: first extended region |
| 111c: first offset region | 112: second metal layer |
| 112a: second metal region | 112b: second extended region |
| 112c: second offset region | 113: third metal layer |
| 113a: third metal region | 113b: third extended region |
| 113c: third offset region | 114: fourth metal layer |
| 114a: fourth metal region | 114b: fourth extended region |
| 114c: fourth offset region | 115: fifth metal layer |
| 115a: fifth metal region | 120: substrate insulating layer |
| 130: metal connector | 200: light emitting device |
| 210: light emitter | 211: first light emitter |
| 212: second light emitter | 213: third light emitter |
| 220: pad | 221: first pad |
| 222: second pad | 223: third pad |
| 224: fourth pad | 230: lead connector |
| 231: first lead connector | 232: second lead connector |
| 233: third lead connector | 234: fourth lead connector |
| 240: device insulating layer | 241: first device insulating layer |
| 242: second device insulating layer | 243: third device insulating layer |
| 244: fourth device insulating layer | 300: driving device |

What is claimed is:

1. A light emitting module, comprising:
a substrate;
a plurality of light emitting devices disposed on the substrate, arranged in one direction, and configured to generate light; and
a driving device configured to control generation of the light from the plurality of light emitting devices,
wherein the substrate includes:
a plurality of metal layers stacked to be electrically connected to at least one of the plurality of light emitting devices and the driving device; and
a substrate insulating layer disposed between the plurality of metal layers, and
wherein at least some of the plurality of metal layers are formed to have different lengths in the one direction when viewed from a cross section where the substrate is cut in the one direction.

2. The light emitting module of claim 1, wherein one of the plurality of metal layers comprises:
a plurality of metal regions arranged spaced apart from each other in the one direction within the cross section,
wherein a length in the one direction of one of the plurality of metal regions is longer than a length in the one direction of another of the plurality of metal regions.

3. The light emitting module of claim 2, wherein the one metal region and the another metal region among the plurality of metal regions are alternately arranged with each other in the one direction.

4. The light emitting module of claim 1, wherein a length in the one direction of one of the plurality of metal layers within the cross section is longer than a length in the one direction of another of the plurality of metal layers.

5. The light emitting module of claim 4, wherein the one of the plurality of metal layers and the another of the plurality of metal layers are alternately stacked with each other within the cross section.

6. The light emitting module of claim 1, wherein the plurality of metal layers includes:
a first metal layer disposed on an upper surface of the substrate insulating layer and including a first metal region extending in the one direction;
a second metal layer disposed below the first metal layer, extending in the one direction, and including a second metal region arranged such that at least a portion of the second metal region overlaps with the first metal region when projected upward;
a third metal layer disposed below the second metal layer, extending in the one direction, and including a third metal region arranged such that at least a portion of the third metal region overlaps with the first metal region and the second metal region when projected upward;
a fourth metal layer disposed below the third metal layer, extending in the one direction, and including a fourth metal region arranged such that at least a portion of the fourth metal region overlaps with the third metal region when projected upward; and
a fifth metal layer disposed below the fourth metal layer, extending in the one direction, and including a fifth metal region arranged such that at least a portion of the fifth metal region overlaps with the fourth metal region when projected upward.

7. The light emitting module of claim 6, wherein a length in the one direction of the first metal region is longer than a length in the one direction of the second metal region,
a length in the one direction of the fourth metal region is longer than the length in the one direction of the first metal region,
a length in the one direction of the fifth metal region is longer than the length in the one direction of the fourth metal region, and
a length in the one direction of the third metal region is longer than the length in the one direction of the fifth metal region.

8. The light emitting module of claim 1, wherein the substrate further includes a metal connector extending in a stacking direction and connected to the plurality of metal layers.

9. The light emitting module of claim 1, wherein the plurality of light emitting devices and the driving device are arranged to be spaced apart from each other in the one direction, and
a separation distance between the plurality of light emitting devices is smaller than a separation distance between one of the plurality of light emitting devices and the driving device.

10. A light emitting module, comprising:
a substrate;
a plurality of light emitting devices disposed on the substrate, arranged in one direction, and configured to generate light; and
a driving device configured to control the generation of light from the plurality of light emitting devices,
wherein the substrate includes a plurality of metal layers stacked to be electrically connected to the driving device and the plurality of light emitting devices, and
wherein when the plurality of metal layers are projected onto a single virtual plane, at least some of the plurality of metal layers are arranged to intersect with each other.

11. The light emitting module of claim 10, wherein the plurality of metal layers includes:
a first metal layer, at least a portion of which extends in the one direction and is electrically connected to the plurality of light emitting devices;
a second metal layer disposed below the first metal layer, electrically connected to the plurality of light emitting devices, and intersecting with the first metal layer as at least a portion of the second metal layer extends in a direction offset from the one direction when viewed from above; and
a third metal layer disposed below the second metal layer, and extending in the direction offset from the one direction so that at least a portion of the third metal layer intersects with the first metal layer and the second metal layer.

12. A light emitting module, comprising:
a substrate;
a plurality of light emitting devices disposed on the substrate and configured to generate light; and
a plurality of driving devices configured to control the plurality of light emitting devices so that the light is generated from the plurality of light emitting devices,
wherein the plurality of light emitting devices are arranged in one direction,
the plurality of driving devices are spaced apart from the plurality of light emitting devices in another direction perpendicular to the one direction and are spaced apart from each other and arranged along the one direction, and
a number of the plurality of light emitting devices is greater than a number of the plurality of driving devices.

13. The light emitting module of claim 12, wherein the substrate includes:
a light emitting device placement region where the plurality of light emitting devices are disposed; and
a driving device placement region where the plurality of driving devices are disposed,
wherein the light emitting device placement region and the driving device placement region extend in the one direction, and
a length in the one direction of the light emitting device placement region is greater than a length in the one direction of the driving device placement region.

14. The light emitting module of claim 13, wherein the light emitting device placement region and the driving device placement region are disposed to be spaced apart from each other in the another direction, and
a separation distance between the light emitting device placement region and the driving device placement region is smaller than a separation distance in the another direction between one of the plurality of light emitting devices and one of the plurality of driving devices.

15. The light emitting module of claim 13, wherein the light emitting device placement region extends from one side surface of one light emitting device of the plurality of light emitting devices disposed closest to one side of the substrate to another side surface, opposite the one side surface, of another light emitting device of the plurality of light emitting devices disposed closest to another side opposite the one side of the substrate, and
the one side surface of the one light emitting device of the plurality of light emitting devices is disposed toward the one side of the substrate, and the another side surface of the another light emitting device of the plurality of light emitting devices is disposed toward the another side of the substrate.

16. The light emitting module of claim 13, wherein the driving device placement region extends from one side surface of one driving device of the plurality of driving devices disposed closest to one side of the substrate to another side surface, opposite the one side surface, of another driving device of the plurality of driving devices disposed closest to another side of the substrate,
the one side surface of the one driving device of the plurality of driving devices is disposed toward the one side of the substrate, and
the another side surface of the another driving device of the plurality of driving devices is disposed toward the another side of the substrate.

17. The light emitting module of claim 12, wherein a separation distance between the plurality of light emitting devices is smaller than a separation distance between the plurality of driving devices.

18. The light emitting module of claim 13, wherein an area of the light emitting device placement region is smaller than an area of the driving device placement region.

19. The light emitting module of claim 12, wherein each of the plurality of light emitting devices includes:
a light emitter configured to generate the light;
a pad disposed below the light emitter and electrically connected to the light emitter; and
a lead connector disposed between the light emitter and the pad to electrically connect the light emitter and the pad,
wherein an area of the lead connector is larger than an area of the pad.

20. The light emitting module of claim 19, further comprising:
a device insulating layer that covers the light emitter, the pad, and the lead connector,
wherein the device insulating layer comprises:
a first device insulating layer disposed on an upper side of the light emitter;
a second device insulating layer disposed on a side surface of the light emitter;
a third device insulating layer disposed on the side surface of the light emitter and disposed below the second device insulating layer; and
a fourth device insulating layer disposed below the light emitter and the third device insulating layer, and covering at least a portion of the lead connector and the pad, and
wherein a light transmittance of the second device insulating layer is lower than a light transmittance of the first device insulating layer.
